(19) United States
(12) Patent Application Publication
(10) Pub. No.: US 2019/0095294 A1
(43) Pub. Date: Mar. 28, 2019

(54) STORAGE UNIT FOR HIGH PERFORMANCE COMPUTING SYSTEM, STORAGE NETWORK AND METHODS

(71) Applicant: Seagate Technology LLC, Cupertino, CA (US)

(72) Inventors: David Michael Davis, Portsmouth (GB); Kenneth Kevin Claffey, Dublin, CA (US); Christopher Bloxham, Chichester (GB)

(21) Appl. No.: 16/189,417

(22) Filed: Nov. 13, 2018

Related U.S. Application Data
(63) Continuation of application No. 13/469,519, filed on May 11, 2012, now abandoned.

(51) Int. Cl. G06F 11/20; H04L 29/08; H04L 12/26; H04L 12/24; G06F 11/30

(52) U.S. Cl. CPC G06F 11/2092; H04L 67/1097; G06F 11/2094; H04L 43/0817; H04L 41/069; H04L 41/0654; G06F 11/2007; H04L 41/0806; G06F 11/2023; G06F 11/2038; G06F 11/3034; H04L 41/0883; G06F 11/3058

(57) ABSTRACT

There is disclosed a storage unit for high performance computing system, a storage network and a method of providing storage and of accessing storage. The storage unit includes an enclosure constructed and arranged to receive plural storage devices to provide high density, high capacity storage. The unit also includes a network connector and at least one integrated application controller constructed and arranged to run a scalable parallel file system for accessing data stored on the storage devices and providing server functionality to provide file access to a client via the network connector.

The present invention relates to a storage unit for a High Performance Computing system, a storage system, a method of providing storage and a method of accessing storage.

High Performance Computing (HPC) is the use of powerful processors, networks and parallel supercomputers to tackle problems that are very compute or data-intensive. At the time of writing, the term is usually applied to systems that function above a teraflop or 1012 floating-point operations per second. The term HPC is occasionally used as a synonym for supercomputing. Common users of HPC systems are scientific researchers, engineers and academic institutions.

The HPC market has undergone a paradigm shift. The adoption of low-cost, Linux-based clusters that offer significant computing performance and the ability to run a wide array of applications has extended the reach of HPC from its roots in scientific laboratories to smaller workgroups and departments across a broad range of industrial segments, from biotechnology and cloud computing, to manufacturing sectors such as aeronautics, automotive, and energy. With dramatic drops in server prices, the introduction of multi-core processors, and the availability of high-performance network interconnects, proprietary monolithic systems have given way to commodity scale-out deployments. Users wanting to leverage the proven benefits of HPC can configure hundreds, even thousands, of low-cost servers into clusters that deliver aggregate compute power traditionally only available in supercomputing environments.

As HPC architecture has evolved, there has been a fundamental change in the type of data managed in clustered systems. Many new deployments require large amounts of unstructured data to be processed. Managing the proliferation of digital data, e.g. documents, images, video, and other formats, places a premium on high-throughput, high-availability storage. The explosive growth of large data has created a demand for storage systems that deliver superior input/output (I/O) performance. However, technical limitations in traditional storage technology have prevented these systems from being optimized for I/O throughput. Performance bottlenecks occur when legacy storage systems cannot balance I/O loads or keep up with high-performance compute clusters that scale linearly as new nodes are added.

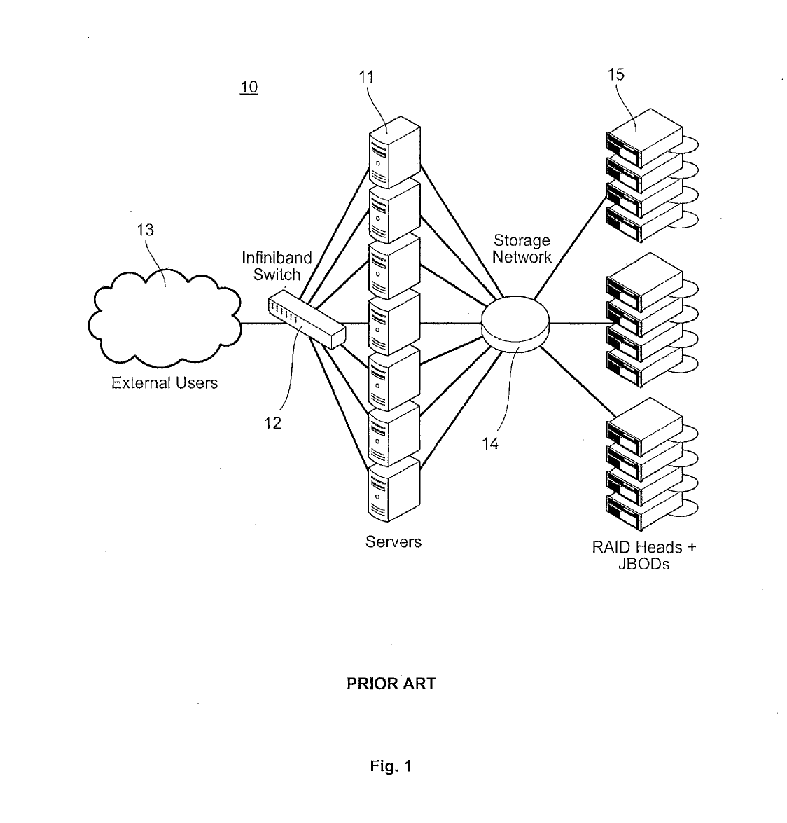

Historically, high performance storage has typically been provided as separate system components, connected via an external interface fabric and grouped into racks. FIG. 1 shows an example of such a system 10. Discrete storage servers 11 are connected to an Infiniband network 12 to interface to the High Performance Computing system 13. These servers 11 would be used to provide an interface through to a separate storage network or SAN 14 to the storage devices 15. The storage network could consist of a high speed interconnect, RAID heads with JBODs (“Just a Bunch Of Disks”) daisy chained behind, servers with associated JBODs or enclosures with integrated RAID function.

This system has a number of deficiencies. All data passes through the front end servers 11, thus these can act as a bottleneck. The discrete components and various external interfaces create an imbalance in system performance as disk drive, storage interconnects and storage processing are not linearly scaled. The topologies used within the SAN also have constraints. The RAID heads are limited if enclosures are daisy chained, as the bandwidth is then constrained to whatever the daisy chain cable connection is capable of. Servers with JBODs also have daisy chain constraints. Enclosures with integrated RAID rarely have sufficient drives to fill the bandwidth capability, requiring either high performance drives, or bottlenecking the performance of an expensive RAID controller. Being created from multiple separate components the system is not as consolidated or dense as it could be.

Thus, despite the advantages in application performance offered by HPC cluster environments, the difficulty in optimizing traditional storage systems for I/O throughput, combined with architectural complexities, integration challenges, and system cost have been barriers to wider adoption of clustered storage solutions in industrial settings.

According to a first aspect of the present invention, there is provided a storage unit for High Performance Computing systems, the storage unit comprising:

an enclosure constructed and arranged to receive plural storage devices to provide high density, high capacity storage;

a network connector; and,

at least one integrated application controller constructed and arranged to run a scalable parallel file system for accessing data stored on said storage devices and providing server functionality to provide file access to a client via the network connector.

The invention integrates block storage, network and file system functions into a single “building block” that delivers a linear or near linear scaling unit in file system performance and capacity. Unlike prior art systems where designing or changing a system requires a large degree of planning and lengthy deployment and testing, not to mention a degree of guess work, the present invention provides a balanced performance building block which delivers a predictable level of performance that scales linearly without storage or network degradation. Preferred embodiments are capable of scaling smoothly and simply from terabytes to tens of petabytes and from 2.5 gigabytes per second to 1 terabyte per second bandwidths.

Preferred embodiments can be configured and/or tested at the point of manufacture, meaning that new systems can be deployed in a matter of hours compared with days and weeks for prior art systems. The present system can also save space and the amount of interconnects required compared with equivalent prior art systems. The system can be made highly consolidated and dense.

Preferably the application controller provides RAID data protection to the storage devices. This provides greater security to the data stored on the storage devices at each node. Also, the RAID capability automatically scales with the rest of the storage unit, i.e. the number of drives in the storage enclosure should be sufficient to efficiently use the bandwidth capacity of the RAID controller/engine (which tend to be expensive), but not too great to bottleneck the performance of the RAID controller. The RAID functionality can be carried out in software or hardware in the application controller. Preferably 8+2 RAID 6 is used, but other RAID arrangements could be used

Preferably there are at least two integrated application controllers in the storage unit arranged to provide redundancy in the storage unit. Having two application controllers in the, unit allows fast communications between the controllers, for example across a midplane in the storage unit, allowing fast response time for resolution of error conditions. This allows for rapid failover and maintains high availability of data access, which is a critical consideration in HPC storage. An example prior art method of failover would be to use an external interface between servers, meaning that both communication and the resulting failover is much slower. This could be two or 3 orders of magnitude slower that failover achievable when the application controllers are tightly integrated into the storage unit.

Preferably the file system is a linearly scaling file system. This allows the storage to be linearly scaled by adding new storage units to a storage network.

The storage unit provides file access to a client, typically supplying portions of a requested file, commonly known as “file segments”. As will be appreciated, using a parallel file system means that segments of a file may be distributed over plural storage units.

In an embodiment, the file system is Lustre. However, other suitable scalable parallel file systems can be used.

In an embodiment, the storage devices are Serial Attached SCSI disk drive units.

In an embodiment, at least one application controller includes a unit management application that monitors and/or controls the storage unit hardware infrastructure and software. For example the management software can monitor overall system environmental conditions, providing a range of services including SCSI Enclosure Services and High Availability capabilities for system hardware and software.

According to a second aspect of the present invention, there is provided a storage network comprising plural storage units as described above and a switch for providing access to at least one user, the storage units being connected to the switch in a star topography. This balances the bandwidth from the storage devices to the bandwidth available from the application controller back ends. The system removes the need for a back end SAN and the associated additional cables and switches.

Preferably the network comprises a metadata server connected to the switch for providing network request handling for the file system and/or a management server connected to the switch for storing configuration information for the file systems in the storage system.

Preferably the network comprises a management server, the management server including a processor for running a system management application for monitoring and controlling the system, wherein the system management program can communicate with storage unit management applications via a separate management network connecting the management server and the storage units. This enables a single point of contact for monitoring and controlling the storage system and the individual storage units and can thus be used to speed up configuring and maintaining the system.

According to a third aspect of the present invention, there is provided a method of accessing storage from a High Performance Computing system, the method comprising a client of the High Performance Computer system reading or writing data to plural storage units connected to the client via a switch with a star topography, each storage unit comprising:

an enclosure constructed and arranged to receive plural storage devices to provide high density, high capacity storage;

a network connector for connecting to said switch; and,

at least one integrated application controller constructed and arranged to run a scalable parallel file system for accessing data stored on said storage devices and providing server functionality to provide file access to a client via the network connector.

Preferably the method comprising increasing the storage capacity of the network and linearly scaling the application controller performance and interconnects by connecting at least one additional storage unit to the switch.

According to a fourth aspect of the present invention, there is provided a method of providing storage to a High Performance Computer system, the method comprising:

connecting plural storage units to a switch with a star topography; and,

connecting a user client of the High Performance Computing system to the switch, wherein each of said plural storage units comprises:

an enclosure constructed and arranged to receive plural storage devices to provide high density, high capacity storage;

a network connector for connecting to said switch; and,

at least one integrated application controller constructed and arranged to run a scalable parallel file system for accessing data stored on said storage devices and providing server functionality to provide file access to a client via the network connector.

In preferred embodiments, the methods can be used with any of the storage units described above.

Embodiments of the present invention will now be described by way of example with reference to the accompanying drawings, in which:

FIG. 1 shows schematically a prior art storage system;

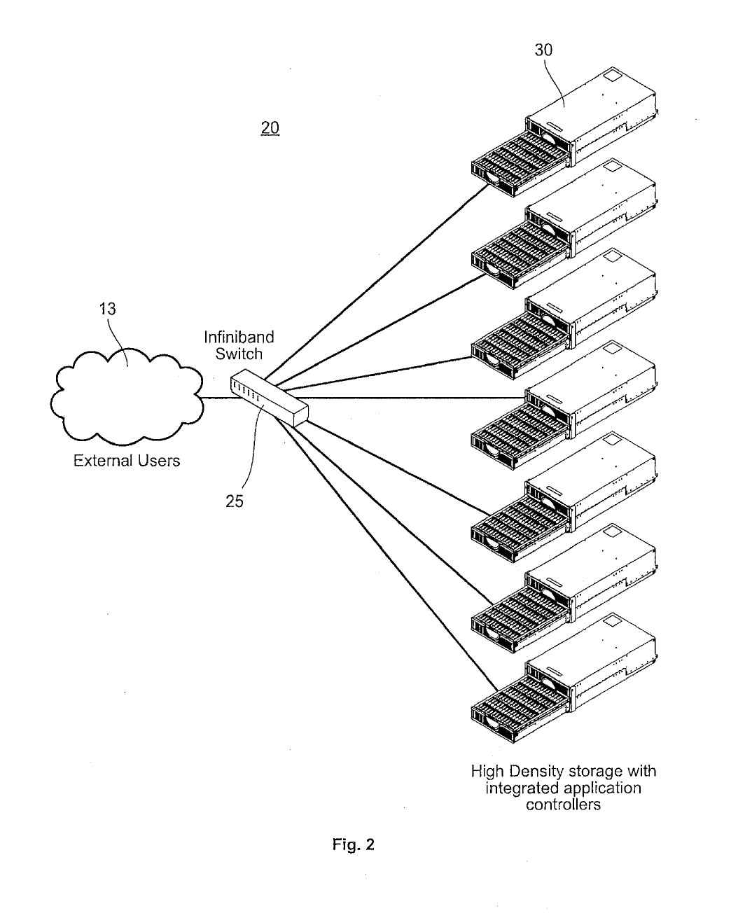

FIG. 2 shows schematically an example of a high performance storage system according to an embodiment of the present invention;

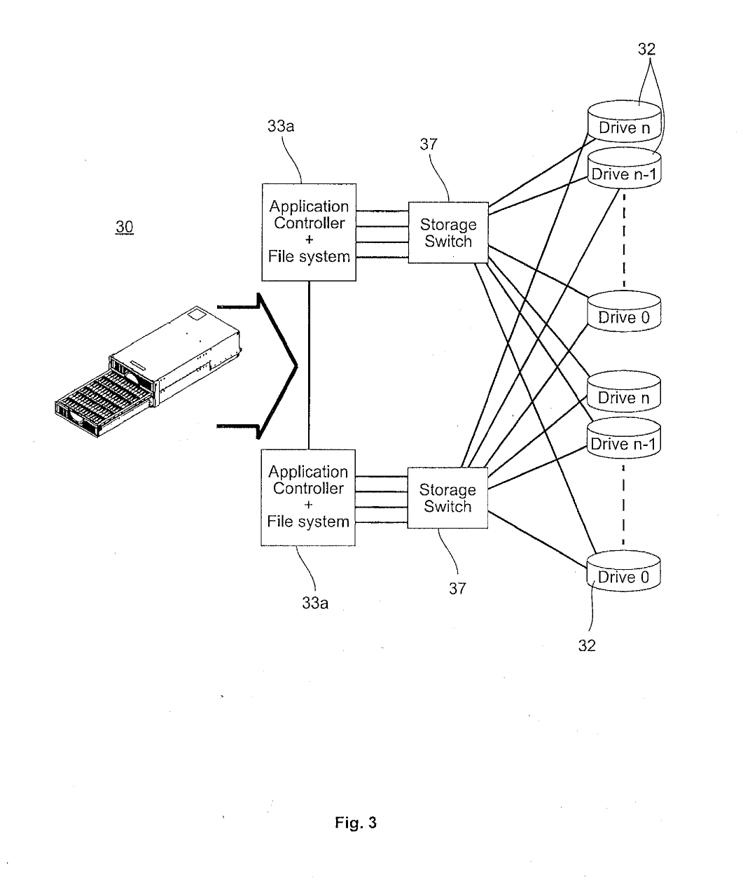

FIG. 3 shows schematically an example of a storage unit according to an embodiment of the present invention;

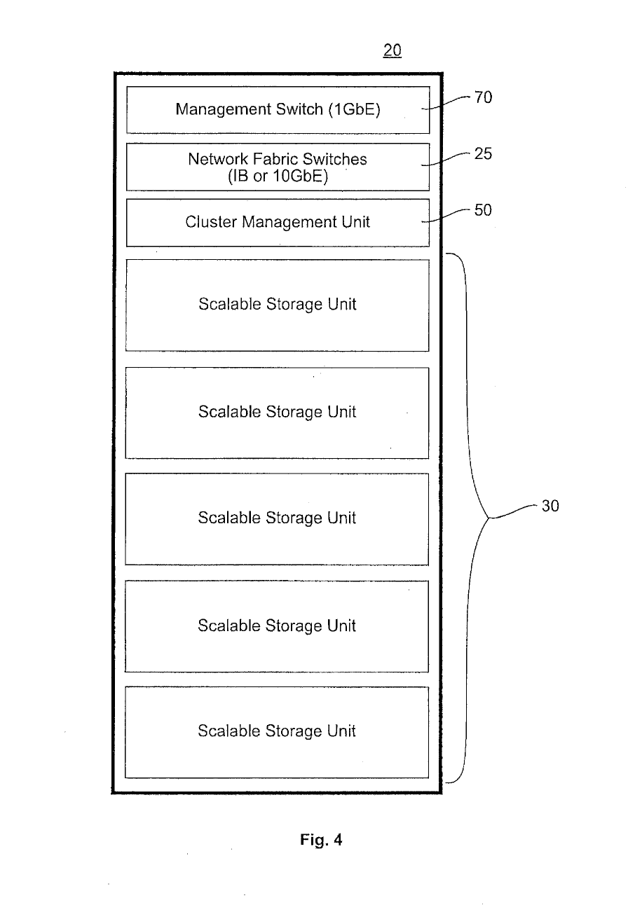

FIG. 4 shows schematically an example of a rack mounted storage system according to an embodiment of the present invention;

FIG. 5 shows schematically an example of a storage unit according to an embodiment of the present invention;

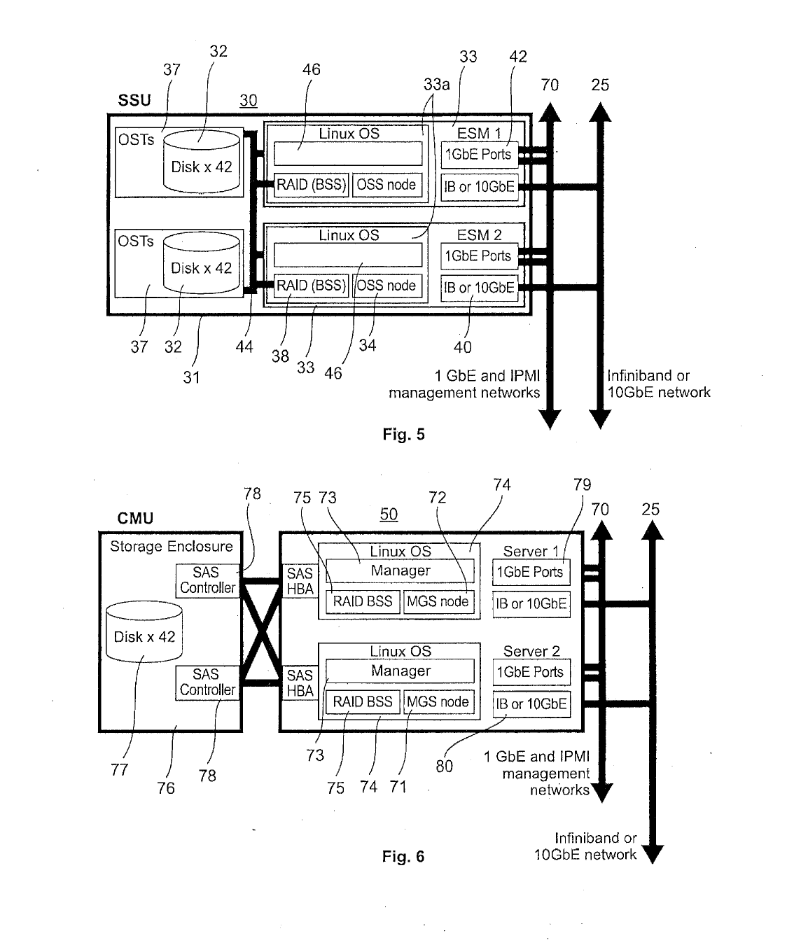

FIG. 6 shows schematically an example of a management unit according to an example of the present invention;

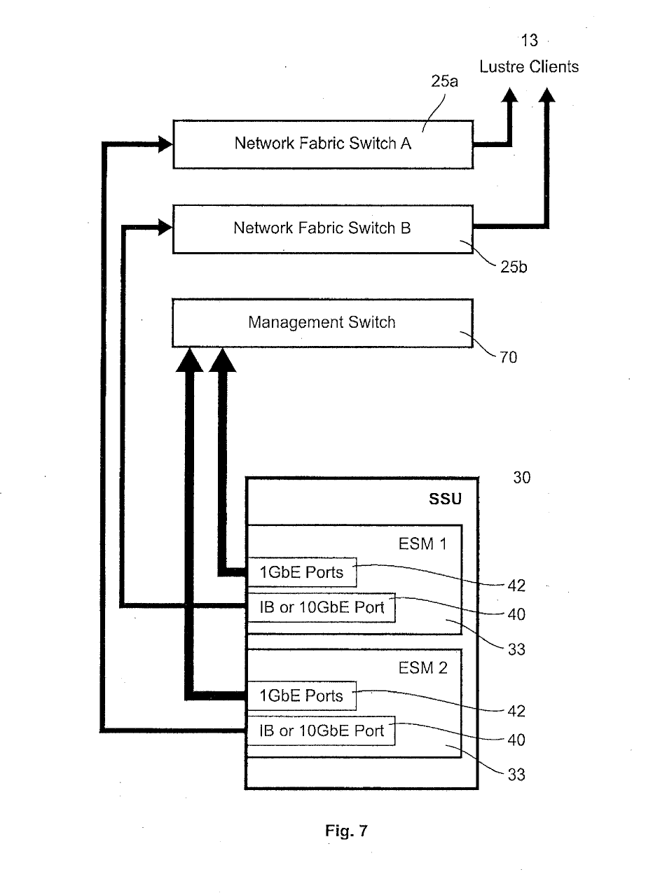

FIG. 7 shows schematically an example of the networking of the system; and,

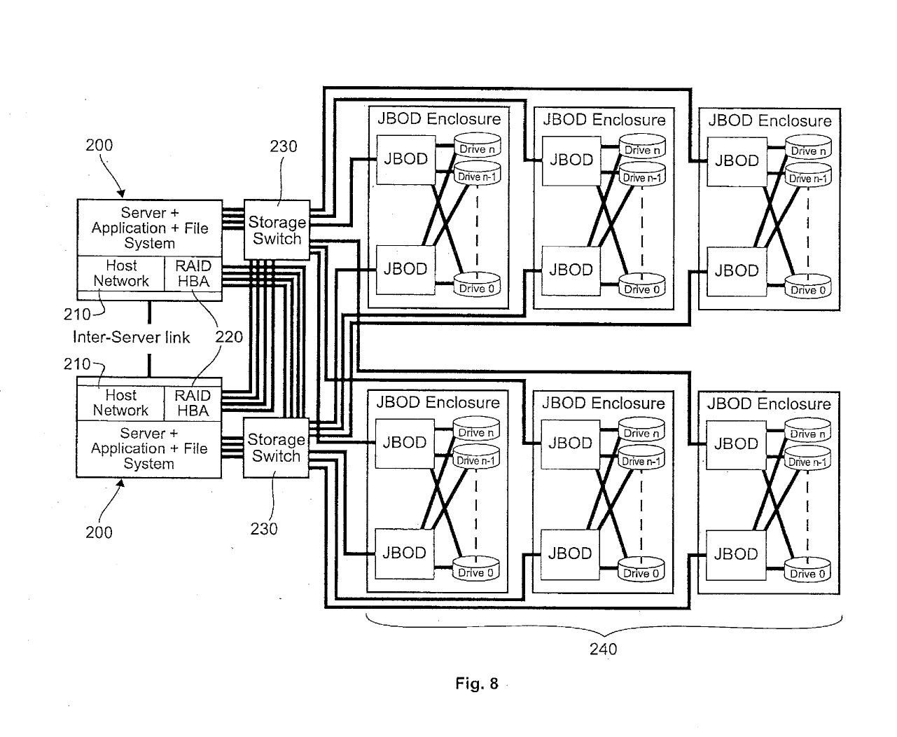

FIG. 8 shows a theoretical storage system made up of discrete components.

FIGS. 2 and 3 show schematically an overview of a high performance storage system 20 according to an embodiment of the present invention. As shown in FIG. 2, plural Scalable Storage Units 30 are connected in a star topology via a switching fabric 25 to user nodes 13. The user nodes 13 can be for example, a High Performance Computing cluster, or supercomputer, or other networked users. The switching fabric 25 can be for example Infiniband or 10 GBe.

The storage system 20 uses a distributed file system that allows access to files from multiple users 13 sharing via a computer network. This makes it possible for multiple users on multiple machines to share files and storage resources. The users do not have direct access to the underlying block storage but interact over the network using a protocol.

As shown by FIG. 3, each SSU 30 comprises high performance application controllers to integrate the file system software and preferably RAID data protection software and management software in the storage enclosure alongside the storage itself 32. This provides the RAID functionality and High Performance Computing interface in a single entity. The application controllers 33a deliver file system data directly from the SSUs 30 to the front-end switch 25 and thence to the users 13.

As will become clear from the following detailed description, this arrangement has numerous advantages over other known systems.

The preferred storage system 25 uses the “Lustre” file system. Lustre is a client/server based, distributed architecture designed for large-scale compute and I/O-intensive, performance-sensitive applications. The Lustre architecture is used for many different types of HPC clusters. For example, Lustre file system scalability has made it a popular choice in the oil and gas, manufacturing, rich media, and finance sectors. Lustre has also been used as a general-purpose data centre back-end file system at various sites, from Internet Service Providers (ISPs) to large financial institutions. However, known complexities in installing, configuring, and administering Lustre clusters have limited broader adoption of this file system technology. As will become apparent from the following, with the introduction of the present storage solution, users can now leverage the advantages of the Lustre file system without facing the integration challenges inherent to a multi-vendor environment.

A brief overview of a Lustre “cluster” is now given. A Lustre cluster is an integrated set of servers that process metadata, and servers that store data objects and manage free space. Together, the metadata and object storage servers present the file system to clients. A Lustre cluster includes the following components: a Management Server (MGS), Metadata Server (MDS), Object Storage Server (OSS) and Clients.

The Management Server (MGS) stores configuration information for all Lustre file systems in a cluster. Each Lustre server contacts the MGS to provide information. Each Lustre client contacts the MGS to retrieve information.

The Metadata Server (MDS) (typically co-located with the MGS) makes metadata available to Lustre clients from the Metadata Target (MDT). The MDT stores file system metadata (e.g. filenames, directories, permissions and file layouts) on disk and manages the namespace. The MDS provides network request handling for the file system.

The Object Storage Server (OSS) provides file I/O service and network request handling for one or more local. Object Storage Targets (OSTs). The OST stores data (files or chunks of files) on a single LUN (disk drive or an array of disk drives).

The Lustre clients, although not part of the network, are computational, visualization, or desktop nodes that mount and use the Lustre file system. Lustre clients see a single, coherent namespace at all times. Multiple clients can simultaneously read and write to different parts of the same file, distributed across multiple OSTs, maximizing the collective bandwidth of network and storage components.

When a client accesses a file, it completes a filename lookup on the MDS. As a result, a file is created on behalf of the client or the layout of an existing file is returned to the client. For read or write operations, the client then interprets the layout in the logical object volume layer, which maps the offset and size to one or more objects, each residing on a separate OST. The client then locks the file range being operated on and executes one or more parallel read or write operations directly to the OSTs, i.e. Lustre is a parallel file system. With this approach, bottlenecks for client-to-OST communications are eliminated, so the total bandwidth available for the clients to read and write data scales almost linearly with the number of OSTs in the filesystem.

The preferred storage system 20 is implemented by rack-mounted devices. FIG. 4 shows an example of a preferred layout. The system 20 comprises plural storage units 30, a cluster management unit 50, which manages file system configuration and metadata, network fabric switches 25, which control the file system I/O, and a management switch 70, which is connected to the other components via a management network (e.g. 1 GbE or IPMI) and controls private system networking between the components.

### Scalable Storage Unit

The core building block of the storage system 20 is the Scalable Storage Unit (SSU) 30, as shown schematically by FIG. 5. Each SSU 30 in the system is configured with identical hardware and software components, and hosts two Lustre OSS nodes.

The platform for the SSU 30 is an ultra-dense storage enclosure 31. A preferred enclosure the applicant's “OneStor”® storage enclosure, disclosed in US-A-2011/0222234 and purpose built for the demands of HPC applications. This is a 5U enclosure containing 84 3.5 inch disk drives 32. This provides an ultra dense architecture and improves rack utilization giving up to two petabytes of storage in a standard data centre rack using today's 3 TB disk drives. The front of the enclosure 31 contains two drawers each having 3 rows of 14 disk drives 32. The rear of the enclosure 32 includes power supply modules and cooling modules (not shown), and bays for I/O or Embedded Server Modules (ESMs) 33 (described below). The enclosure 31 includes dampening technologies that minimize the impact of rotational vibration interference (RVI) on disk drives 32 from RVI sources, including cooling fans and other disk drives, and other enclosures mounted in the same rack. Maintaining disk drive performance is a key design challenge in high-density storage system design and is achieved by reducing drive RVI. If RVI is not controlled, individual drive performance can degrade by 20% or more, and this is then compounded by system re-tries and Operating System delays to seriously impact system performance.

Within the enclosure 31, all disk drives 32 are individually serviceable and hot swappable. Additionally, each disk drive 32 is equipped with individual drive power control, enabling superior availability with drive recovery from soft errors. The SSU platform uses “Nearline” SAS-based disk drives, which offer the cost/capacity benefits of traditional, high-capacity SATA disk drives, but with a native SAS interface to mitigate data integrity risks and performance limitations associated with using SATA as the disk drive interface protocol. Additionally, the SAS disk drives are natively dual-ported with multi-initiator support, to facilitate the fast and reliable failover of disk drives. This obviates the need for discrete SATA/SAS multiplexer modules, which are required when using SATA disk drives in high-availability architectures. Nonetheless, other types of storage device and arrangements of storage device are possible for use with the present invention.

Each enclosure 31 has two industry-standard Embedded Server Modules (ESMs) 33. Each ESM 33 has an application controller 33a including its own dedicated x86 CPU complex, memory, network and storage connectivity, and which is capable of running Linux distributions upon which various software programs are executed. Each ESM 33/application controller 33a provides a Lustre OSS node 34 for accessing the disk drives 32 as shared OST storage 35. Each ESM 33/application controller 33a has an integrated RAID XOR engine 38 and a high-speed, low-latency cache which organises and provides access to the disk drives 32 via SAS controllers/switches 37. Each ESM 33 also has either a 40G QDR InfiniBand or 10 GbE port 40 for data network host connections. Additionally, each ESM 33 connects, via 1 GbE ports 42, to the dedicated management and IPMI networks.

The enclosure 31 includes multiple high-speed inter-controller links across a common midplane 44 for communication between ESMs 33 for synchronization and failover services. This efficient and highly reliable design enables the SAS infrastructure to deliver robust performance and throughput of up to 2.5 GB/sec per SSU for reads and writes.

The ESMs 33 are preferably compliant with the Storage Bridge Bay specification. Each ESM 33 is a Field Replaceable Unit (FRU) and is accessible at the rear of the enclosure 31 for field service and upgrade.

The SSU 30 is fully redundant and fault-tolerant, thus ensuring maximum data availability. Each ESM 33 serves as a Lustre OSS node 34, accessing the disk drives 32 as shared OST storage 36 and providing active-active failover. If one ESM 33 fails, the active ESM 33 manages the OSTs 36 and the disk drive operations of the failed ESM 33. In non-failure mode, the I/O load is balanced between the ESMs 31.

The RAID subsystem 38 configures each OST 36 with a single RAID 6 array to protect against double disk failures and drive failure during rebuilds. The 8+2 RAID sets support hot spares so that when a disk drive 32 fails, its data is immediately rebuilt on a spare disk drive 32 and the system does not need to wait for the disk drives 32 to be replaced. This subsystem also provides cache protection in the event of a power failure. The OSS cache is preferably protected by the applicant's unique “Metis Power Protection” technology as disclosed in US-A-2011/0072290. When a power event occurs, Metis Power Protection technology supplies reserve power to protect in-flight storage data, enabling it to be securely stored on persistent media, i.e. redundant flash disk. This is a significant advantage over traditional cache memory protection or having to use external UPS devices within the storage rack.

Additionally, the system uses write intent bitmaps (WIBS) to aid the recovery of RAID parity data in the event of a failed server module or a power failure. For certain types of failures, using WIBS substantially reduces parity recovery time from hours to seconds. In the present example, WIBS are used with Solid State Devices (mirrored for redundancy), enabling fast recovery from power and OSS 34 failures without a significant performance impact.

Each ESM 33 runs sophisticated management software 46 arranged to monitor and control the SSU 30 hardware infrastructure and overall system environmental conditions, providing a range of services including SCSI Enclosure Services and High Availability capabilities for system hardware and software. The software 46 monitors and manages system health, providing Remote Access Services that cover all major components such as disks, fans, PSUs, SAS fabrics, PCIe busses, memories, and CPUs, and provides alerts, logging, diagnostics, and recovery mechanisms. The software 46 allows power control of hardware subsystems which can be used to individually power-cycle major subsystems including storage devices, servers, and enclosures. The software 46 also preferably provides fault-tolerant firmware upgrade management. The software 46 provides efficient adaptive cooling to maintain the SSU in optimal thermal condition, using as little energy as possible. The software 46 provides extensive event capture and logging mechanisms to support file system failover capabilities and to allow for post-failure analysis of all major hardware components.

### Cluster Management Unit

As shown by FIG. 6, the Cluster Management Unit (CMU) 50 features the MDS node 71, which stores file system metadata and configuration information, the MGS node 72, which manages network request handling, and management software 73, which is the central point of management for the entire storage cluster, monitoring the various storage elements within the cluster.

The CMU 50 comprises a pair of servers 74, embedded RAID 75, and one shelf of high-availability shared storage 76. Preferably the storage is provided by SAS disk drives 77 accessed via SAS controllers 78. Cluster interface ports 79, 80 support InfiniBand or 10 GbE data networks and 1 GbE management network connections.

The CMU 50 is fully redundant and fault-tolerant. Each node is configured for active-passive failover, with an active instance of the node running on one system and a passive instance of the node running on the peer system. If an active node fails, e.g. the MDS node 71 fails, then the passive MDS node 71 takes over the MDT operations of the failed MDS node 71. The RAID 75 protects the cache of the CMU 50 and, in the event of a power outage, writes it to persistent storage, i.e. a redundant flash disk. The shared storage of the CMU 50 supports a combination of Small Form Factor (SFF) SAS HDD and SSD drives, protected using RAID 1, for management data, file system data, and journal acceleration.

The SSU 30 supports InfiniBand or 10 GbE connections to the MDS and MGS nodes 71, 72. Accordingly, each server 74 in the CMU 50 is configured to operate with either network fabric. Additionally, each server 74 connects, via Ethernet ports 79, to dedicated private management networks supporting IPMI.

Thus, the CMU 50 provides a centralized High Availability management node for all storage elements in the cluster.

The CMU 50 also runs management software 73 which provides a single-pane-of-glass view of the system to an administrator. It includes a browser-based GUI that simplifies cluster installation and configuration, and provides consolidated management and control of the entire storage cluster.

Additionally, the management software 73 provides distributed component services to manage and monitor system hardware and software.

The management software 73 includes intuitive wizards to guide users through configuration tasks and node provisioning. Once the cluster is running, administrators use the GUI to effectively manage the storage environment—e.g. start and stop file systems, manage node failover, monitor node status, and collect and browse performance data. Additionally, the dashboard reports errors and warnings for the storage cluster and provides extensive diagnostics to aid in troubleshooting, including cluster-wide statistics, system snapshots, and Lustre syslog data.

To ensure maximum availability, the management software 73 works with the systems integrated management software 46 in the SSUs 30 to provide comprehensive system health monitoring, error logging, and fault diagnosis. On the GUI, users are alerted to changing system conditions and degraded or failed components.

### Network Fabric Switches

The Network Fabric Switches 25 (InfiniBand or 10 GbE) manage I/O traffic and provide network redundancy throughout the storage system 20. As shown by FIG. 7, to maximize network reliability, the ESMs 33 in the SSU 30 are connected to network switches 25a,25b providing redundancy. If one switch 25a fails, the second module 33 in the SSU 30, which is connected to the active switch 25b, manages the OSTs 36 of the module 33 connected to the failed switch 25a.

Additionally, to maintain continuous management connectivity within the system, the network switches 25 are fully redundant at every point and interconnected to provide local access from the MDS nodes 71 and MGS nodes 72 to all storage nodes.

### Management Switch

The management switch 70 consists of a dedicated local network on a 1 GbE switch, with an optional redundant second switch, which is used for configuration management and health monitoring of all components in the system 20. The management network is private and not used for data I/O in the cluster. This network is also used for IPMI traffic to the ESMs 33 in the SSUs 30, enabling them to be power-cycled by the management program 73.

Thus, the preferred embodiments avoid or improve the deficiencies of the prior art in several ways.

When new SSUs 30 are added to the cluster, performance scales linearly as incremental processing network connectivity and storage media are added with each unit. This modular design removes the performance limitation of traditional scale-out models in which servers or RAID heads quickly become the bottleneck as more drives are added to the cluster. The system 20 combines enclosure and server enhancements with software stack optimizations to deliver balanced I/O performance (even on large data workloads), and outperform traditional storage topologies by adding easy-to-install, modular SSUs 30 that scale ESMs 33 as HPC storage scales, distributing I/O processing throughout the system 20.

The system 20 uses a high capacity, high availability storage enclosure 31 to provide a star topology from the storage interface 25 to the disk drives 32. This balances the bandwidth from the disk drives 32 to the bandwidth available from the application controller 33a back end.

The system 20 uses high performance application controllers 33a to integrate the File System software running together with the RAID data protection software in the storage enclosure alongside the storage itself. This provides the RAID functionality and High Performance Computing interface in a single entity. The application controllers 33a provide sufficient processing power and scale-out at sufficient bandwidth down to the high number of drives within the SSUs 30, which allows the application controllers 33a to provide high throughput, high bandwidth and provide industry-leading or class-leading performance at an aggregate rack level. Hence it removes the requirement for the back end SAN (e.g. switch 14 in FIG. 1) and allows the application controllers 33a to deliver file system data directly from the SSUs 30 to the front-end switch 25. The removal of the back end SAN 14 is also an infrastructure saving because associated cabling and dedicated switches can be avoided.

Use of an appropriate file system, such as Lustre, also allows the system 20 to be linearly scalable, since the combination of high performance application controllers 33a running within the storage enclosure 31 provide an OSS “appliance” each capable of in excess of 250 TB of storage capacity.

Use of an OSS “appliance” allows a compact, high capacity, high performance storage system to be created which has supremely linear scalability.

The tight integration of components within a single high density enclosure 31 offers significant benefits over traditional separate elements.

Firstly, this has space/density benefits. A single 5U enclosure 31 houses the equivalent of approximately 20U of separate elements (e.g. 2×1U Servers+6×3U 14 drive enclosures).

The preferred enclosure 31 reduces the number of power supplies (and associated power cords) in the system 20 whilst maintaining redundancy. In doing so, it also optimises the system 20, providing the right amount of high efficiency power to the enclosure 31. Other components are also optimised. For example, since the enclosure 31 is a defined configuration, the number and type of SAS ports can be reduced and accordingly the SAS interconnecting cables.

The preferred enclosure 31 has close coupling between application controllers 33a. The fact that the application controllers 33a both reside in the same enclosure 31, connected to the same high availability midplane 44 allows fast response times for resolution of error conditions. The fast response time allows for rapid failover and maintains high availability of data access. In the preferred embodiment, the controller 33a can get high speed notification of issues with a partner controller 33a in less than 1 ms.

In contrast, within a system having separate components, one controller 33a would have to “ping” the other over the network, incurring a delay of 10 s of seconds, plus complex error handling depending on the response, or lack of response.

FIG. 8 shows how the functionality of the SSU could be provided from separate components, i.e. servers 200 with network cards 210 and RAID HBAs 220, storage switches 230, and individual JBOD enclosures 240. This shows the additional complexity and proliferation of interconnects required by this system compared with the present system 20 and thus illustrates some key advantages of the present system 20.

Another type of storage solution which is known and commercially available is a high density Network Attached Storage unit. These serve as stand alone systems containing storage devices which serve a file to a user over a network. However, these do not use parallel file systems and are not intended to “scale out” in performance. These therefore are not relevant to the problems faced in providing improved storage for High Performance Computing with which the present invention is concerned.

Embodiments of the present invention have been described with particular reference to the example illustrated. However, it will be appreciated that variations and modifications may be made to the examples described within the scope of the present invention.

1-22. (canceled)

23. A storage unit, comprising:
an enclosure with
a plurality of storage drives arranged in the enclosure;
at least two network connectors, the network connectors configured to facilitate communication with the storage drives by a plurality of clients; and
at least two server modules embedded in the enclosure and communicatively connected via a plurality of inter-controller links across a common midplane, each server module comprising a hardware application controller configured to run a parallel file system for accessing data stored on the storage drives and to provide file access to the plurality of clients via the network connectors.

24. A storage unit according to claim 23, wherein the enclosure is configured to be inserted in a data center rack.

25. A storage unit according to claim 23, comprising eighty-four storage drives.

26. A storage unit according to claim 23, wherein each of the hardware application controllers provides RAID data protection to the storage drives.

27. A storage unit according to claim 23, wherein the parallel file system is a linearly scaling file system.

28. A storage unit according to claim 27, wherein the parallel file system is a distributed file system.

29. A storage unit according to claim 23, wherein each of the hardware application controllers includes a unit management application configured to monitor and control hardware infrastructure and software of the storage unit.

30. A storage unit according to claim 23, wherein each server module is configured to provide active-active failover for other server modules.

31. A system comprising:
a plurality of storage units, each comprising:
a plurality of storage devices;
at least two network connectors, the network connectors configured to facilitate communication with the storage devices by a plurality of clients; and
at least two hardware modules communicatively connected via a plurality of inter-controller links across a common midplane, each hardware module comprising a controller configured to run a parallel file system for accessing data stored on the storage devices and to provide file access to the plurality of clients via the network connectors;
a switch coupled to each of the storage units in a star topography and configured to provide access to at least one user; and
a cluster management unit.

32. A system according to claim 31, further comprising a metadata server coupled to the switch and configured to provide network request handling for the parallel file system.

33. A system according to claim 31, further comprising a management server, the management server comprising a processor configured to run a system management application, wherein the system management application communicates with storage unit management applications operating on each of the plurality of storage units via a private management network connecting the management server and the plurality of storage units.

34. A system according to claim 31, wherein the cluster management unit comprises at least two server modules and each cluster management server module is configured to operate with a plurality of network fabrics.

35. A system according to claim 34, wherein the plurality of network fabrics includes at least one of InfiniBand and 10 gigabit ethernet.

36. A system according to claim 31, wherein each of the controllers provides RAID data protection with the parallel file system in each storage unit hardware module.

37. A system according to claim 36, wherein the RAID data protection includes supporting hot spare storage devices.

38. A system according to claim 31, wherein each of the plurality of storage devices is hot swappable.

39. A method, comprising:
connecting a plurality of storage units to a switch in a star topography to provide a high performance computing system network; and
connecting a host of a high performance computing system to the switch, each storage unit comprising:
an enclosure housing a plurality of storage devices;
at least two network connectors configured to facilitate communication with the storage devices by the client; and
at least two server modules embedded in the enclosure and communicatively connected via a plurality of links across a common midplane, each server module comprising an application controller configured to run a distributed parallel file system for accessing data stored on the storage devices and to provide file access to the host via the network connectors.

40. A method according to claim 39, further comprising:
increasing the storage capacity of the network and linearly scaling application controller performances and interconnects by coupling at least one additional storage unit to the switch.

41. A method according to claim 40, further comprising:
connecting a metadata server to the switch to provide network request handling for the distributed parallel file system.

42. A method according to claim 40, further comprising:
connecting a management server to the switch, the management server comprising a processor configured to run a system management application, wherein the system management application communicates with storage unit management applications operating on each of the plurality of storage units via a private management network connecting the management server and the plurality of storage units.
